(19) United States
(12) Patent Application Publication
(10) Pub. No.: US 2026/0080760 A1
(43) Pub. Date: Mar. 19, 2026

(54) DIFFERENTIATING ALARM SIGNAL STATES ON HARDWIRED COMMUNICATION LINE IN HYBRID ALARM SYSTEMS

(71) Applicant: Kidde Fire Protection, LLC, Bradenton, FL (US)

(72) Inventors: Wojciech Stankiewicz, Gdansk (PL); Jeffrey I. Collard, Colorado Springs, CO (US)

(21) Appl. No.: 19/318,046

(22) Filed: Sep. 3, 2025

Related U.S. Application Data
(60) Provisional application No. 63/696,684, filed on Sep. 19, 2024.

(51) Int. Cl. G08B 7/06; G08B 25/00; G08B 25/08; G08B 25/10; G08C 17/00

(52) U.S. Cl. CPC G08B 7/06; G08B 25/001; G08B 25/08; G08B 25/10; G08C 17/00

(57) ABSTRACT

A hybrid alarm includes a hardwire alarm network and a wireless alarm network. The hardwire alarm network includes at least one hardwire alarm node. The wireless alarm network includes a first wireless alarm node in signal communication with the hardwire alarm node via a first wired connection, and in signal communication with a second wireless alarm node via one or both of a second wired connection and a wireless connection. The first and second wireless alarm nodes are configured to detect an emergency event, and in response to detecting the emergency event output one or both of a wired alarm signal via the second wired connection and a wireless alarm signal via the wireless connection. The wired alarm signal includes at least one digital code indicating the emergency event is already acknowledged.

### CROSS-REFERENCE TO RELATED APPLICATIONS

This application claims the benefit of U.S. Provisional Application No. 63/696,684 filed Sep. 19, 2024, the disclosure of which is incorporated herein by reference in its entirety.

### BACKGROUND

The embodiments described herein relate generally to alert alarm systems, and more particularly, to hybrid alert systems.

Current technology used in communication between interconnected emergency alarms supports only limited amount of information. As system expand to incorporate new technologies, such as hardwired/interconnected connection and wireless/interlinked connection products, there is a gap in supported features and device performance. Conventional alarm systems, however, do not facilitate connection between multiple interconnected networks with single interlinked network.

### SUMMARY

According to a non-limiting embodiment, a hybrid alarm system comprises a hardwire alarm network and a wireless alarm network. The hardwire alarm network includes at least one hardwire alarm node. The wireless alarm network includes a first wireless alarm node in signal communication with the hardwire alarm node via a first wired connection, and in signal communication with a second wireless alarm node via one or both of a second wired connection and a wireless connection. Each of the first and second wireless alarm nodes are configured to detect an emergency event, and in response to detecting the emergency event output one or both of a wired alarm signal via the second wired connection and a wireless alarm signal via the wireless connection. Each of the wired and wireless alarm signal indicate the emergency event. The wired alarm signal includes at least one digital code indicating the emergency event is already acknowledged.

In addition to one or more of the features described above, or as an alternative to any of the foregoing embodiments, the at least one digital code includes an alarm confirm signal indicating the emergency event is already acknowledged, and an alarm cancel signal indicating the emergency event is cancelled.

In addition to one or more of the features described above, or as an alternative to any of the foregoing embodiments, the first and second wireless alarm nodes refrain from transmitting the wireless alarm signal in response to receiving the alarm confirm digital code.

In addition to one or more of the features described above, or as an alternative to any of the foregoing embodiments, the alarm confirm digital code received via the wired alarm signal indicates that the emergency event was previously detected prior to receiving wireless alarm signal.

In addition to one or more of the features described above, or as an alternative to any of the foregoing embodiments, the first and second wireless alarm nodes are permitted to transmit the wireless alarm signal in response to receiving the alarm cancel digital code.

In addition to one or more of the features described above, or as an alternative to any of the foregoing embodiments, the at least one digital code includes one or a combination of a smoke detection code indicating a smoke detection event, a carbon monoxide (CO) code indicating a CO detection event, and a power test code indicating a power test event.

In addition to one or more of the features described above, or as an alternative to any of the foregoing embodiments, the wireless connection includes one or a combination of a radio frequency (RF) connection and Wi-Fi connection.

In addition to one or more of the features described above, or as an alternative to any of the foregoing embodiments, the at least one hardwire alarm node includes a plurality of hardwire alarm nodes directly connected to one another via a respective wired connection.

According to another non-limiting embodiment, a method of controlling a hybrid alarm system is provided. The method comprises establishing a hardwire alarm network including at least one hardwire alarm node, and establishing, via a first wired connection, signal communication between a first wireless alarm node included in a wireless alarm network and at least one hardwire alarm included in a hardwire alarm network, and establishing, via one or both of a second wired connection and a wireless connection, signal communication between a second wireless alarm node included in the wireless alarm network. The method further comprises detecting an emergency event by each of the first and second wireless alarm nodes, and in response to detecting the emergency event, outputting one or both of a wired alarm signal via the second wired connection and a wireless alarm signal via the wireless connection, each of the wired and wireless alarm signal indicating the emergency event, and indicating that the emergency event is already acknowledged using at least one digital code included in the wired alarm signal.

Technical effects of embodiments of the present disclosure include the ability to prevent looping issues in complex in hybrid alarm systems that include both hardwired nodes and wireless nodes. The present disclosure also provides faster alarm propagation between two or more wireless nodes to prevent alarm loops. Accordingly, the hybrid alarm system described herein facilitates improved better performance for wireless smart alarm networks by reducing or limiting alarms frames that are transmitting between two or more wireless nodes, and allowing for the addition of new features.

The foregoing features and elements may be combined in various combinations without exclusivity, unless expressly indicated otherwise. These features and elements as well as the operation thereof will become more apparent in light of the following description and the accompanying drawings. It should be understood, however, that the following description and drawings are intended to be illustrative and explanatory in nature and non-limiting.

### BRIEF DESCRIPTION OF THE DRAWINGS

The present disclosure is illustrated by way of example and not limited in the accompanying figures in which like reference numerals indicate similar elements.

FIGS. 1A-1D, an alarm loop scenario commonly encountered by a hybrid alarm system;

FIG. 2 illustrates a hybrid alarm system capable of differentiating alarm signal states on hardwired communication interface (HWI) is illustrated according to a non-limiting embodiment of the present disclosure;

FIG. 3 depicts a wireless alarm node included in the hybrid alarm system of FIG. 2 according to a non-limiting embodiment of the present disclosure;

FIG. 4A depicts a smoke emergency digital code utilized in the hybrid alarm system of FIG. 2 according to a non-limiting embodiment of the present disclosure;

FIG. 4B depicts a carbon monoxide (CO) emergency digital code utilized in the hybrid alarm system of FIG. 2 according to a non-limiting embodiment of the present disclosure;

FIG. 5A depicts an alarm confirm digital code utilized in the hybrid alarm system of FIG. 2 according to a non-limiting embodiment of the present disclosure; and

FIG. 5B depicts an alarm cancel digital code utilized in the hybrid alarm system of FIG. 2 according to a non-limiting embodiment of the present disclosure.

### DETAILED DESCRIPTION

Conventional emergency alarm systems encounter compatibility issues when attempting to establish different connections or hybrid connections (e.g., both wired connections and wired connections) in multiple interconnected networks using single interlinked network. These issues cause problems when attempting to exchange additional types of data between alarm nodes included in individual networks of a multi-network, hybrid-connection alarm network.

One problem that commonly occurs in a conventional multi-network, hybrid-connection alarm network is an alarm loop. The alarm loop can be established when a mismatch in the timing of signal propagation occurs between multiple alarm nodes. Due to the lack of data exchanged between alarm nodes, one or more of the alarm nodes may not realize the emergency event was previously detected by the alarm system, and will then output its own alarm signal onto the network, creating what appears to be a newly detected alarm event. This alarm loop can lead to undesired repeated or ongoing alarm activations.

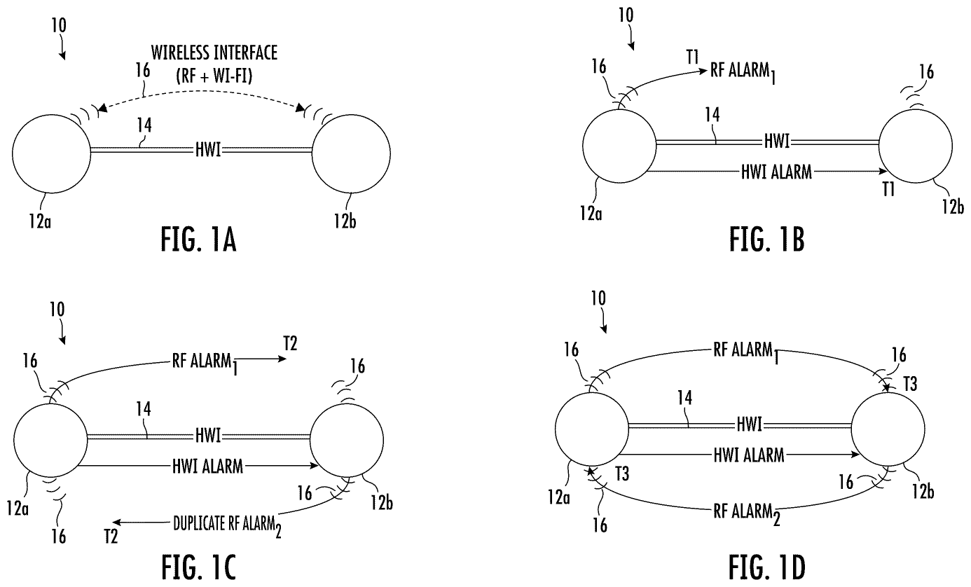

With reference to FIGS. 1A-1D, an alarm loop scenario commonly encountered by a hybrid alarm system 10 is illustrated. The hybrid alarm system 10 illustrated in FIG. 1A includes a first wireless alarm node 12a and a second wireless alarm node 12b. The first and second wireless alarm nodes 12 and 12b are in signal communication with one another via a hybrid connection. As referred herein, the hybrid connection implements both a hardwired interface (HWI) 14 and a wireless interface 16 (e.g., a radio frequency interface, Bluetooth interface, Wi-Fi interface, etc.).

Both the first and second wireless alarm nodes are configured to generate alarm signals in response to detecting an emergency event. The HWI 14 is configured to exchange a wired alarm signal (HWI alarm), while the wireless interface 16 is configured to exchange a wireless alarm signal (RF alarm). Receiving HWI alarm and/or RF alarm initiated a sending wireless alarm node (e.g., first wireless alarm node 12a) will cause another wireless alarm node (e.g., the second wireless alarm node 12b) to output (e.g. broadcast) its own wireless alarm signal, which can be received by sending alarm node (e.g., the first wireless alarm node 12a) and/or any other wireless alarm node in signal communication with the wireless interface 16.

FIG. 1B illustrates the hybrid alarm system 10 following an emergency event detected by the first wireless alarm node 12a. In response to detecting the emergency event, the first wireless alarm node 12a generates at time T1 both a wired alarm signal (HWI alarm) and a wireless alarm signal (RF alarm1). HWI alarm is output via the HWI 14, while RF alarm1 is output via the wireless interface 16. As shown in FIG. 1B, however, RF alarm1 may lag HWI alarm. As a result, HWI alarm may be received by the second wireless alarm node 12a before RF alarm1.

Referring to FIG. 1C, the second wireless alarm node 12B is activated in response to receiving HWI alarm and outputs its own wireless alarm signal (RF alarm 2) at T2. At this time (T2), however, the RF alarm1 output from the first wireless alarm node 12a still has not yet been received by the second wireless alarm node 12b. As a result, two separate wireless alarm signal (e.g., RF alarm1 and RF alarm2) are being broadcast concurrently.

In FIG. 1D, the hybrid alarm system 10 is shown at time T3, when the second wireless alarm node 12b receives the initial RF alarm 1 while the first wireless alarm node 12a receives RF alarm2. The concurrent generation of RF alarm1 and RF alarm 2 creates an alarm loop that maintains the first wireless alarm node 12a and the second wireless alarm node 12b in an undesirable constant and continuous emergency activation state.

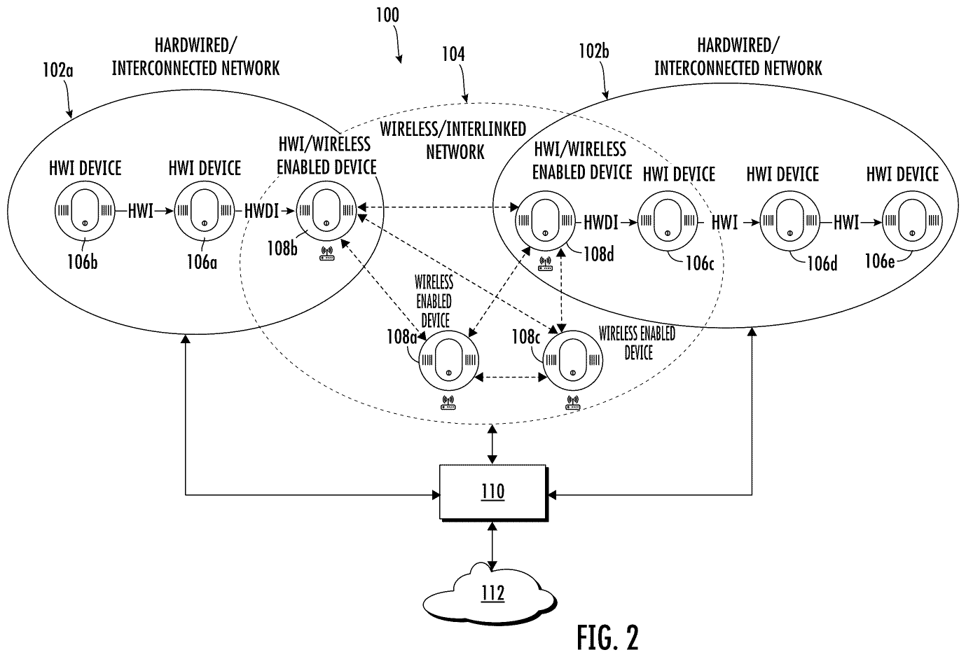

Turning now to FIG. 2, a hybrid alarm system 100 capable of differentiating alarm signal states on hardwired communication interface (HWI) is illustrated according to a non-limiting embodiment of the present disclosure. The hybrid alarm system 100 includes a first hardwired interconnected alarm network (e.g., a first hardwire alarm network) 102a, a second hardwire alarm network 102b, a wireless interlinked network (e.g., a wireless alarm network) 104, a network node 110 (the network node includes, for example, fire panels, security panels, or other types of controllers or accessory devices that can be utilized in an emergency alarm system; The network node 110 can include the identifier information for each of the networks 102a, 102b, 104, the individual alarm nodes operating therein, and the version of firmware that each alarm node is currently operating), and a cloud computing network 112.

The first hardwire alarm network 102a includes a first hardwire alarm node 106a and a second hardwire alarm node 106b. The second hardwire alarm network 102b includes a third hardwire alarm node 106c, a fourth hardwire alarm node 106d, and a fifth hardwire alarm node 106e. The first and second hardwire alarm nodes 106a and 106b are in signal communication with one another (e.g., serial wired connection) via a hardwire interface (HWI). Although two hardwire alarm nodes 106a and 106b are shown, it should be appreciated that more or less hardwire alarm nodes can be implemented. Likewise, the third, fourth, and fifth hardwire alarm nodes 106c, 106d and 106e are in signal communication with one another (e.g., serial wired connection) via a hardwire interface (HWI). Although three hardwire alarm nodes 106c, 106d and 106e are shown, it should be appreciated that more or less hardwire alarm nodes can be implemented.

Each of the first, second, third, fourth and fifth hardwire alarm nodes (collectively referred to as hardware alarm nodes 106a-106e) can be implemented as a multi-function alarm node. For example, the hardwire alarm nodes 106a-106e can each operate to detect smoke (e.g., a smoke (SM) emergency event and/or fire emergency event) and carbon monoxide (CO) (e.g., CO emergency event). Accordingly, each of the hardware alarm nodes 106a-106e can be activated and output a smoke alarm signal in response to detecting smoke. Likewise, each of the hardware alarm nodes 106a-106e can be activated and output a CO alarm signal in response to detecting CO.

The wireless alarm network 104 includes a first wireless alarm node 108a, a second wireless alarm node 108b, a third wireless alarm node 108c, and a fourth wireless alarm node 108d (collectively referred to as wireless alarm nodes 108a-108d). Although four wireless alarm nodes 108a-108d are shown, it should be appreciated that more or less wireless alarm nodes can be implemented. The wireless alarm nodes 108a-108d are in signal communication with one another via a hybrid connection interface or a hardwire/digital interface (HWDI). As described herein, the hybrid connection interface implements both a hardwired interface (HWI) and a wireless interface (e.g., a radio frequency interface, Bluetooth interface, Wi-Fi interface, etc.). According to a non-limiting embodiment, one or more of the wireless alarm nodes 108a-108d are in signal communication with a hardwire alarm node 106a-106e via a HWI. For example, the second wireless alarm node 108b is in signal communication with the first hardwire alarm node 106b via a first wired connection, and the fourth wireless alarm node 108d is in signal communication with the third hardwire alarm node 106c via a second wired connection.

Each of the wireless alarm nodes 108a-108d can be implemented as a multi-function smart alarm node. For example, the wireless alarm nodes 108a-108d can each operate to detect smoke (e.g., a smoke (SM) emergency event and/or fire emergency event) and carbon monoxide (CO) (e.g., a CO emergency event). Accordingly, each of the wireless alarm nodes 108a-108d can be activated and output a smoke alarm signal in response to detecting smoke. Likewise, each of the wireless alarm nodes 108a-108d can be activated and output a CO alarm signal in response to detecting CO. The smoke alarm signal and/or the CO alarm signal can be exchanged via the HWI (e.g., a wired connection) and/or the wireless interface (e.g., a wireless connection).

The first hardwire alarm network 102a, second hardwire alarm network 102b, and wireless alarm network 104 are in signal communication with the network node 110. Accordingly, the network node 110 can detect one or more activated hardwire alarm nodes 106a-106e and/or one or more activated wireless alarm nodes 108a-108d, and determine a location of the activated hardwire alarm nodes 106a-106e and/or one the activated wireless alarm nodes 108a-108d. In addition, the network node 110 can determine the type of emergency event (e.g., smoke emergency event and/or CO emergency event) detected by the activated hardwire alarm nodes 106a-106e and/or one the activated wireless alarm nodes 108a-108d.

The network node 110 is in signal communication with the cloud computing network 112. The cloud computing network 112 can store a history of detected emergency events, false detection events, service/maintenance events, and configuration information. The cloud computing network 112 can also store various digital codes that can be included (e.g., digitally embedded) with an alarm signal. The digital codes can include, for example, a smoke detection code indicating a smoke detection event, a CO code indicating a carbon monoxide detection event, and a power test code indicating a power test event, a location code indicating a location of an activated hardwire alarm node and/or activated wireless alarm node, an alarm confirm signal indicating the emergency event is already acknowledged, and an alarm cancel signal indicating the emergency event is cancelled.

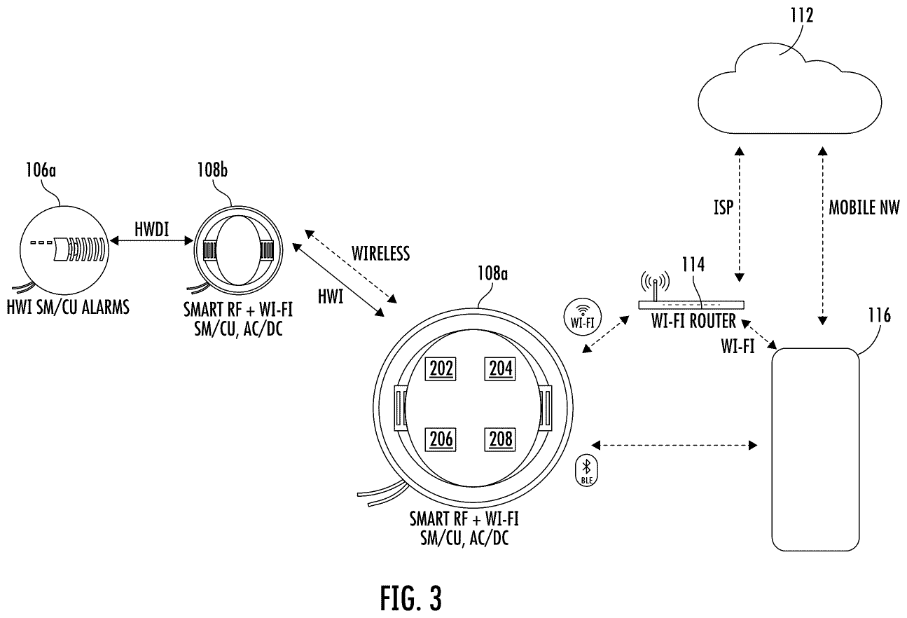

FIG. 3 depicts a wireless alarm node 108a installed in the hybrid alarm system 100 according to a non-limiting embodiment of the present disclosure. Although the following descriptions refer to wireless alarm node 108a, it should be appreciated that the descriptions can apply to each of the wireless alarm modes 108a-108d included in a wireless interlinked network 104. The wireless alarm node 108a can exchange data with

With continued reference to FIG. 3, the wireless alarm node 108a includes one or more processors 202, a memory 204, an communication interface 206, and a network adapter 208. In one or more embodiments of the disclosure, the processor 202 can include a processor 202 of a general-purpose computer, special purpose computer, or other programmable data processing apparatus configured to execute instruction via the processor of the computer or other programmable data processing apparatus.

The wireless alarm node 108a can include a variety of computer system readable media. Such media may be any available media that is accessible by the wireless alarm node 108a, and it includes both volatile and non-volatile media, removable and non-removable media. Memory 204 can include computer system readable media. The memory 204 can include any one or combination of volatile memory elements (e.g., random access memory (RAM, such as DRAM, SRAM, SDRAM, etc.)) and nonvolatile memory elements (e.g., ROM, erasable programmable read only memory (EPROM), electronically erasable programmable read only memory (EEPROM), etc.). The memory 204 can include other removable/non-removable, volatile/non-volatile computer system storage media. The processor 202 and memory 204 are configured to carry out the operations for the wireless alarm node 108a.

The memory 204 may include one or more program modules (not shown) such as operating system(s), one or more application programs, other program modules, program data, operating instructions, algorithms, etc. The memory 204 can also store different digital codes that can be embedded in an emergency alarm signal. Each of the operating systems, one or more application programs, other program modules, and program data or some combination thereof, may include an implementation of a networking environment. The program modules generally carry out the functions and/or methodologies of embodiments of the invention as described herein.

The wireless alarm node 108a may also communicate with one or more remotely located wireless alarm nodes 108b and/or remotely located hardwired nodes (not shown) through the communication interface 206. As described herein, the communication interface 206 is implemented as a hybrid communication interface that includes both a HWI and a wireless interface. The HWI can be utilized to deliver wired alarm signals, while the wireless interface can be utilized to deliver wireless alarm signals.

The network adapter 208 allows the wireless alarm node 108a to communicate with one or more network devices 114, which provides access to one or more data networks 112 such as a local area network (LAN), a general wide area network (WAN), a public network (e.g., the Internet) and/or a cloud computing network. It should be understood that although not shown, other hardware and/or software components could be used in conjunction with the wireless alarm node 108a. It can be appreciated the wireless alarm node 108a can include other components or modules and is not limited by the components shown in FIG. 3.

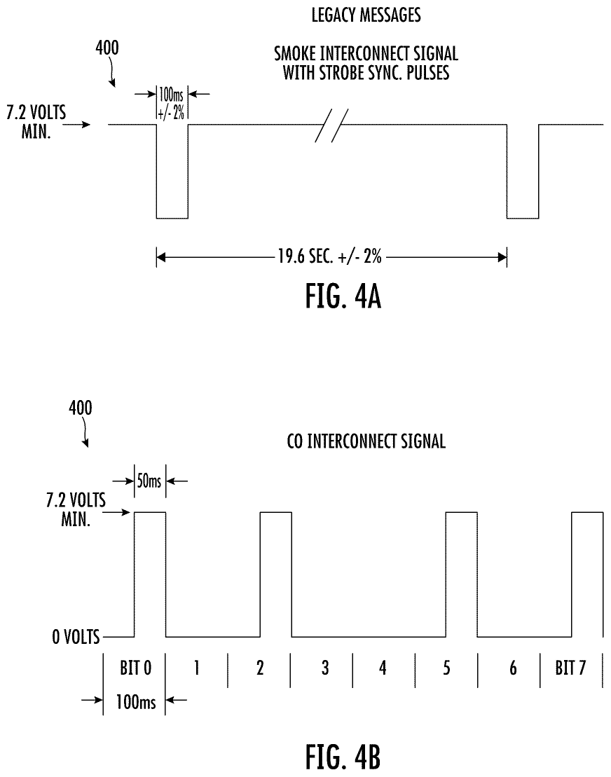

As described herein, a wired alarm signal and/or wireless alarm signal can be generated as one or more digital codes indicating a particular detected emergency event. FIG. 4A, for example, depicts a digital smoke alarm signal 400 having a first digital code indicating a detected smoke emergency event. Likewise, FIG. 4B depicts a digital CO alarm signal 402 having a second digital code indicating a detected carbon monoxide emergency event. The digital smoke alarm signal 400 and the digital CO alarm signal 402 can be generated by any of the hardwire alarm nodes 106a-106e and/or any of the wireless alarm nodes 108a-108d.

The wireless alarm nodes 108a-108d can also generate digital signals having additional digital codes to convey additional information to the wireless alarm nodes 108a-108d. The additional digital codes include, but are not limited to, a power test code indicating a power test event, a location code indicating a location of an activated hardwire alarm node 106a-106e and/or activated wireless alarm node 108a-108d, an alarm confirm signal indicating the emergency event is already acknowledged, and an alarm cancel signal indicating the emergency event is cancelled.

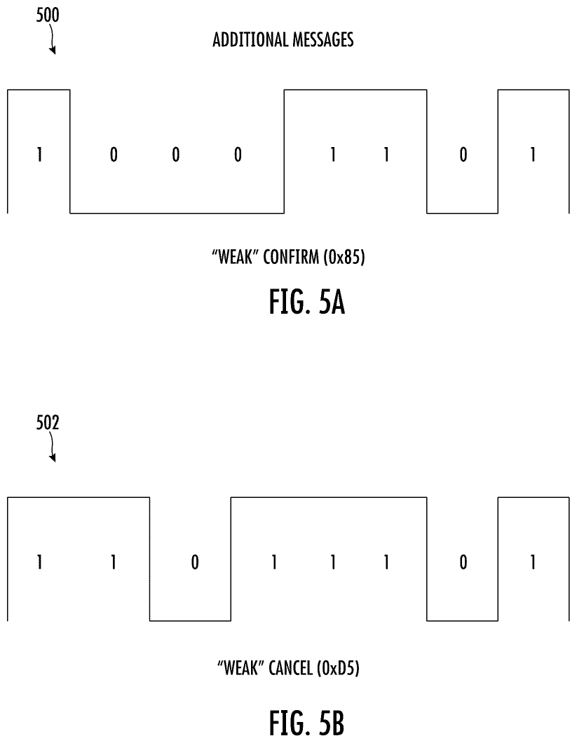

FIG. 5A, for example, depicts an alarm confirm digital code included in a first wireless signal 500, while FIG. 5B depicts an alarm cancel digital code included in a second wireless signal 502. A given wireless alarm node (e.g., (e.g., a first-to-detect wireless alarm node 108a) not only outputs an emergency alarm signal 400 or 402 via the HWI in response to detecting a corresponding emergency event, but also outputs the wireless signal 500 including the alarm confirm digital code via the wireless interface to indicate the corresponding emergency event is already acknowledged. Accordingly, another wireless alarm node (e.g., 108b-108d) can be informed that the emergency alarm signal 400 or 402 has already been acknowledged by the hybrid alarm system 100. That is, the alarm confirm signal 500 indicates that the emergency event indicated by the emergency alarm signal 400 or 402 was previously detected prior to receiving wireless alarm signal 400 or 402 from the HWI and effectively commands the other wireless alarm node (108b-108d) to refrain from outputting its own emergency alarm signal 400 or 402. In this manner, an alarm loop can be avoided. In one or more embodiments, the other wireless alarm node (108b-108d) can still generate and output wireless signals according to the additional digital codes (e.g., a power test code indicating a power test event, a location code indicating a location of an activated hardwire alarm node 106a-106e and/or activated wireless alarm node 108a-108d).

When the emergency event is resolved, the first-to-detect wireless alarm node 108a can output the wireless signal having the alarm cancel digital code 502. Accordingly, the other wireless alarm nodes (108b-108d) that receive the wireless signal having the alarm cancel digital code 502 are permitted to output a wireless alarm signal 400 or 402.

As described above, embodiments can be in the form of processor-implemented processes and devices for practicing those processes, such as a controller. Embodiments can also be in the form of computer program code containing instructions embodied in tangible media, such as network cloud storage, SD cards, flash drives, floppy diskettes, CD ROMs, hard drives, or any other computer-readable storage medium, wherein, when the computer program code is loaded into and executed by a computer, the computer becomes a device for practicing the embodiments. Embodiments can also be in the form of computer program code, for example, whether stored in a storage medium, loaded into and/or executed by a computer, or transmitted over some transmission medium, loaded into and/or executed by a computer, or transmitted over some transmission medium, such as over electrical wiring or cabling, through fiber optics, or via electromagnetic radiation, wherein, when the computer program code is loaded into an executed by a computer, the computer becomes a device for practicing the embodiments. When implemented on a general-purpose microprocessor, the computer program code segments configure the microprocessor to create specific logic circuits.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

Those of skill in the art will appreciate that various example embodiments are shown and described herein, each having certain features in the particular embodiments, but the present disclosure is not thus limited. Rather, the present disclosure can be modified to incorporate any number of variations, alterations, substitutions, combinations, sub-combinations, or equivalent arrangements not heretofore described, but which are commensurate with the scope of the present disclosure. Additionally, while various embodiments of the present disclosure have been described, it is to be understood that aspects of the present disclosure may include only some of the described embodiments. Accordingly, the present disclosure is not to be seen as limited by the foregoing description, but is only limited by the scope of the appended claims.

What is claimed is:

1. A hybrid alarm system comprising:
a hardwire alarm network including at least one hardwire alarm node;
a wireless alarm network including a first wireless alarm node in signal communication with the at least one hardwire alarm node via a first wired connection, and in signal communication with a second wireless alarm node via one or both of a second wired connection and a wireless connection,
wherein each of the first and second wireless alarm nodes includes a controller configured to detect an emergency event, and in response to detecting the emergency event configured to output one or both of wired alarm signal that includes at least one digital code indicating the emergency event is already acknowledged via a second wired connection and a wireless alarm signal via a wireless connection.

2. The hybrid alarm system of claim 1, wherein the at least one digital code includes an alarm cancel digital code indicating the emergency event is cancelled.

3. The hybrid alarm system of claim 2, wherein the at least one digital code further includes an alarm confirm digital code indicating the emergency event is already acknowledged, and wherein the first and second wireless alarm nodes are configured to refrain from transmitting the wireless alarm signal in response to receiving the alarm confirm digital code.

4. The hybrid alarm system of claim 3, wherein the alarm confirm digital code received via the wired alarm signal indicates that the emergency event was previously detected prior to receiving the wireless alarm signal.

5. The hybrid alarm system of claim 1, wherein the first and second wireless alarm nodes are permitted to transmit the wireless alarm signal in response to receiving the alarm cancel digital code.

6. The hybrid alarm system of claim 3, wherein the at least one digital code further includes one or a combination of a smoke detection code indicating a smoke detection event, a carbon monoxide (CO) code indicating a CO detection event, and a power test code indicating a power test event.

7. The hybrid alarm system of claim 1, wherein the wireless connection includes one or a combination of a radio frequency (RF) connection and Wi-Fi connection.

8. The hybrid alarm system of claim 1, wherein the at least one hardwire alarm node includes a plurality of hardwire alarm nodes directly connected to one another via a respective wired connection.

9. A method of controlling a hybrid alarm system, the method comprising:
establishing a hardwire alarm network including at least one hardwire alarm node;
establishing, via a first wired connection, signal communication between a first wireless alarm node included in a wireless alarm network and the at least one hardwire alarm node included in the hardwire alarm network;
establishing signal communication between the first wireless alarm node and a second wireless alarm node included in the wireless alarm network;
detecting an emergency event by each of the first and second wireless alarm nodes; and
in response to detecting the emergency event, outputting one or both of a wired alarm signal which includes at least one digital code indicating the emergency event is already acknowledged via a second wired connection and a wireless alarm signal via a wireless connection.

10. The method of claim 9, wherein the at least one digital code further includes an alarm cancel digital code indicating the emergency event is cancelled.

11. The method of claim 10, further comprising refraining from transmitting the wireless alarm signal from the first and second wireless alarm nodes in response to delivering the alarm confirm digital code thereto.

12. The method of claim 11, further comprising indicating that the emergency event was previously detected prior to receiving the wireless alarm signal based on the alarm confirm digital code.

13. The method of claim 9, further comprising permitting the first and second wireless alarm nodes to transmit the wireless alarm signal in response to receiving the alarm cancel digital code.

14. The method of claim 13, wherein:
the at least one digital code includes one or a combination of a smoke detection code indicating a smoke detection event, a carbon monoxide (CO) code indicating a CO detection event, and a power test code indicating a power test event; and
the wireless connection includes one or a combination of a radio frequency (RF) connection and Wi-Fi connection.

15. The method of claim 9, wherein the at least one hardwire alarm node includes a plurality of hardwire alarm nodes directly connected to one another via a respective wired connection.
